(19) United States
(12) Patent Application Publication
(10) Pub. No.: US 2025/0134191 A1
(43) Pub. Date: May 1, 2025

(54) GAMER GLOVE

(71) Applicant: Gauntlet Gaming, LLC, Gilbert, AZ (US)

(72) Inventors: Fernando Manjarres, Mesa, AZ (US); Daniel Cisneros, Gilbert, AZ (US)

(21) Appl. No.: 18/931,456

(22) Filed: Oct. 30, 2024

Related U.S. Application Data
(60) Provisional application No. 63/594,088, filed on Oct. 30, 2023.

(51) Int. Cl. A41D 19/00; A41D 19/015; A41F 1/06; A63F 13/98

(52) U.S. Cl. CPC A41D 19/0037; A41D 19/0017; A41D 19/01547; A41F 1/06; A63F 13/98

(57) ABSTRACT

A gamer glove is provided. The gamer glove includes a glove body portion having a palm side and a back side. Further, the gamer glove includes a strap coupled to the palm side of the glove. An opening is formed between the strap and palm side of the glove. The opening is configured to receive a handle of a controller within the opening and engaged by the strap and the palm side of the glove. The gamer glove holds the controller with the glove and allows the gamer to use a desired gaming grip, such as, but not limited to, a standard grip and a claw grip.

### CROSS REFERENCE TO RELATED APPLICATION[S]

This application claims priority to U.S. Provisional Patent Application entitled “GAMER GLOVE,” Ser. No. 63/594,088, filed Oct. 30, 2023, the disclosure of which is hereby incorporated entirely herein by reference.

### BACKGROUND OF THE INVENTION

### Technical Field

This invention relates generally to a glove for use by a gamer and more particularly to a gamer glove that holds a gaming controller in the palm of the gamer.

### State of the Art

Gaming is very popular and there are thousands of gamers around the world. Gaming often includes hours of time playing a game and holding a gaming controller in order to control game interaction and play the game by the gamer. Gloves have become common gear utilized by gamers to provide additional grip of the controller and further to provide additional grip using different texture of materials to provide the grip when holding the controller. These conventional gloves are lacking in the ability to hold the controller to glove.

Accordingly, there is a need for an improved gamer glove that holds the controller to a palm side of the glove to support the controller without the need of support from fingers of the hand of the gamer.

### SUMMARY OF THE INVENTION

An embodiment may include a gamer glove comprising: a glove body portion having a palm side and a back side; an attachment device coupled to the glove; and an opening formed between the attachment device and palm side of the glove, wherein the opening receives a handle of a controller within the opening and with the attachment device and the palm side of the glove engage the handle of the controller.

Another embodiment may include a gamer glove comprising: a glove body portion having a palm side and a back side; at least one glove attachment device coupled to the palm side of the glove; and at least one controller attachment device coupled to a handle of a controller, wherein the at least one glove attachment device is releasably coupled to the at least one controller attachment device.

Another embodiment may include a method of using a gamer glove, the method comprising: coupling a gamer glove to the hand of a user, the gamer glove comprising an attachment device; coupling a handle of a controller to the attachment device of the gamer glove; holding the controller with the hand of the user utilizing only the attachment device; and operating the controller to play a game.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1A is a perspective view of back side a gamer glove according to an embodiment;

FIG. 1B is a perspective view of a palm side of a gamer glove according to an embodiment;

FIG. 1C is a rear view of a strap of a gamer glove according to an embodiment;

FIG. 2 is a perspective view of a gamer glove coupled to a controller according to an embodiment;

FIG. 3 is a perspective view of a gamer glove coupled to a controller according to an embodiment;

FIG. 4 is a perspective view of a gamer glove coupled to a controller according to an embodiment;

FIG. 5 is a perspective view of a palm side of a gamer glove according to an embodiment;

FIG. 6 is a perspective view of a controller according to an embodiment;

FIG. 7 is a perspective view of a second embodiment of a gamer glove coupled to a controller according to an embodiment; and

FIG. 8 is a perspective view of a second embodiment of a gamer glove coupled to a controller according to an embodiment.

### DETAILED DESCRIPTION OF EMBODIMENTS OF THE INVENTION

As discussed above, embodiments of the present invention relate to gamer glove that holds a gaming controller in the palm of the gamer.

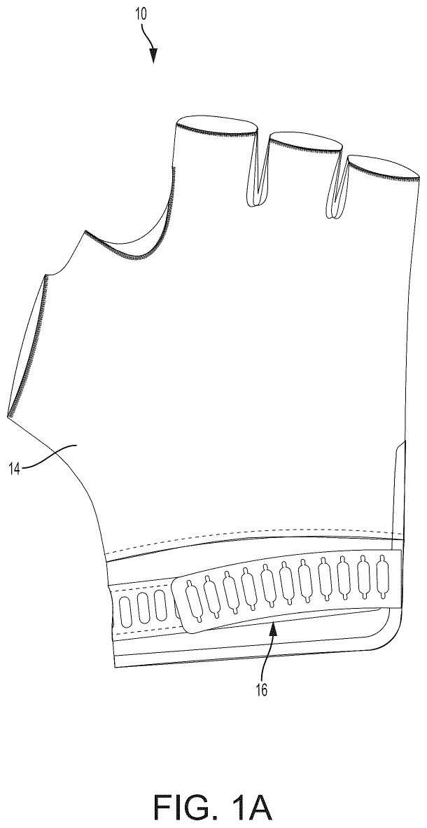

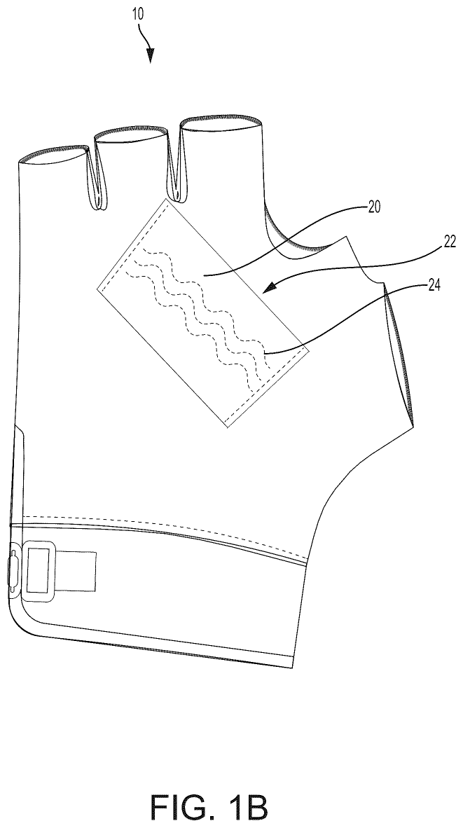

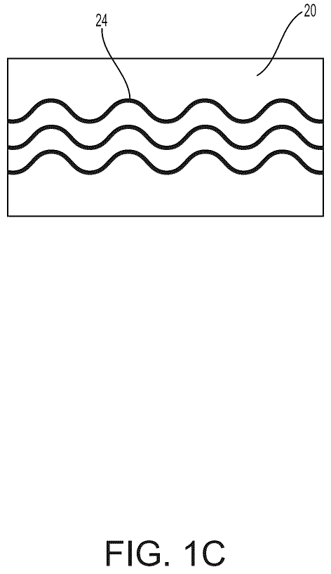

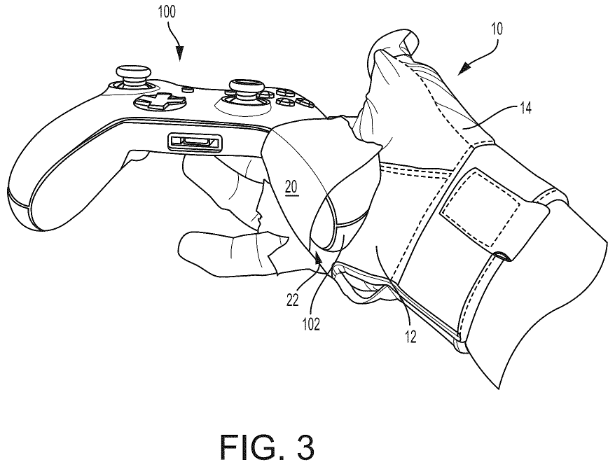

A first embodiment of a gamer glove 10 is depicted in FIGS. 1A-4. The first embodiment includes a gamer glove 10 comprising a glove body portion 18 with a palm side 12 and a back side 14. The gamer glove 10 comprises an attachment device 20 coupled to the glove 10. The glove 10 further comprises an opening 22 that is formed between the attachment device 20 and palm side 12 of the glove 10. Additionally, the glove 10 may include a wrist lock 16, wherein the wrist lock is adjustable to couple the glove 10 to the wrist of the user. The wrist lock may be a hook-and-loop fastener or a lock having male and female pieces. The glove 10 may be formed of any material. For example, and without limitation, the glove 10 may be a performance stretch jersey material, a leather material, a perforated neoprene, and so forth.

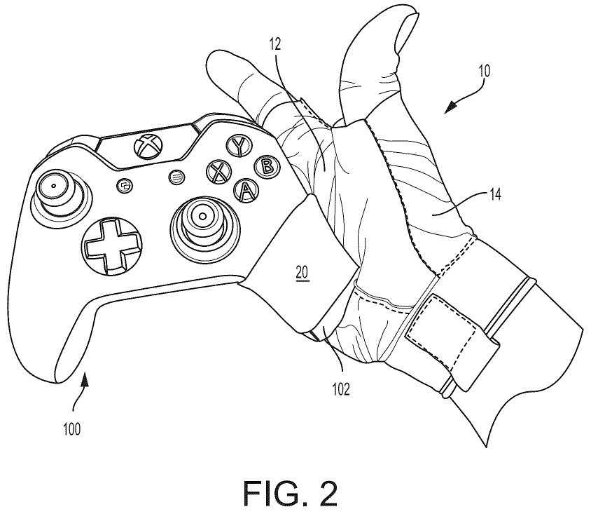

As shown in FIGS. 2-4, the opening 22 is configured to receive a handle 102 of a controller 100 within the opening 22. The handle 102, when coupled to the glove 10, is engaged by the attachment device 20 and the palm side 14 of the glove 10.

As depicted in FIGS. 1A-4, the attachment device 20 may be, without limitation, a strap 20 and may be formed of an elastomeric material. The strap 20 formed of elastomeric material is therefore stretchable to accommodate different sizes of handles 102 of different types of controllers 100. The stretching of the strap 20 results in an adjustable size of opening 22. Further, the strap 20 may be stretched to expand the opening 22 to a size large enough to receive a portion of the controller 100, such as the handle 102, and the characteristics of the elastomeric material of the strap 20 cause the material to retract and increase friction between the strap 20 and the portion of the controller 100, such as the handle 102, that is received within the opening 22.

In the embodiment shown in FIGS. 1A-4, the strap 20 is coupled to the palm side 12 of the glove 10. However, other embodiments (not shown) may include the strap 20 that is coupled to the back side 14 of the glove 10, wherein the strap 20 wraps around the glove 10 and forms the opening 22 between the strap 20 and the palm side 12 of the glove 10 to receive the handle 102 of the controller 100. For example, the strap 20 may be an elastomeric material coupled on both ends to the back side 14 of the glove; the strap 20 may be an elastomeric material coupled on one end to the back side of the glove and on the other end to the palm side 12 of the glove 10; the strap 20 may be a hook-and-loop strap that is coupled on the back side 14 of the glove 10 and wraps around and couples to the other hook-and-loop material on either the back side 14 of the glove 10 or on the strap 20; or the strap 20 may be any include any other configuration with means of coupling the strap 20 to a back side 14 of the glove 10 while providing the opening 22 between the strap 20 and the palm side 12 of the glove 10.

In some embodiments, without limitation, as depicted in FIGS. 1B and 1C, the inner surface of the attachment device 20 may comprise one or more gripping members 24. The gripping members 24 provide additional friction between the strap 20 and the handle 102 of the controller 100 when the handle 102 is coupled within the opening 22 between the strap 20 and the palm side 12 of the glove 10. In embodiments, the gripping members 24 may, without limitation, be formed of silicone or other types of gripping material or material with increased friction.

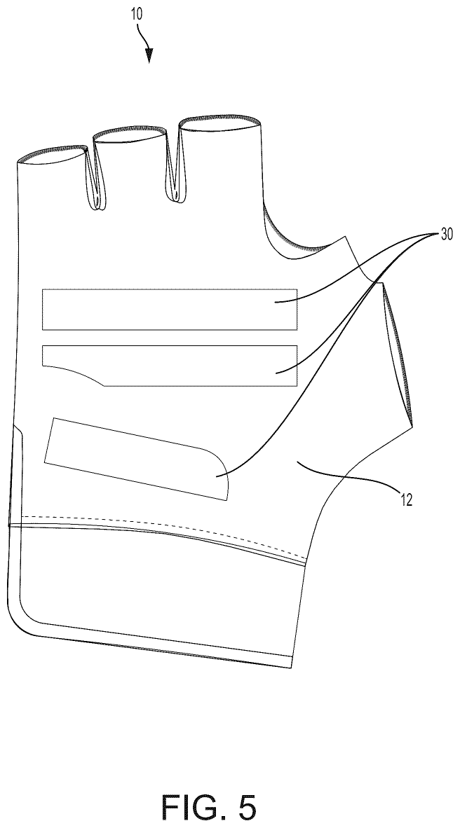

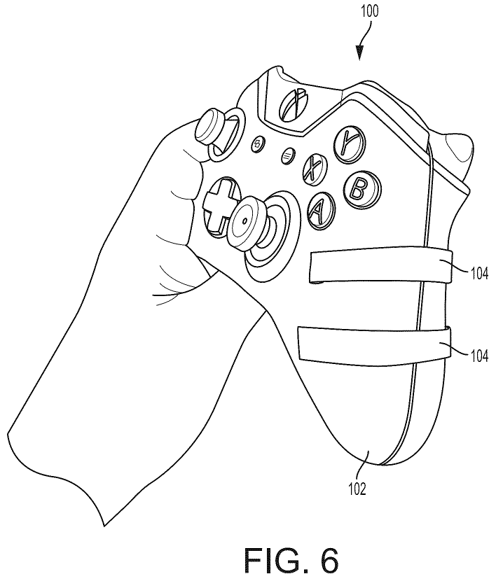

A second embodiment of a gamer glove 10 is depicted in FIGS. 5-8. The first embodiment includes a gamer glove 10 comprising a palm side 12 and a back side 14. Referring to FIG. 5, the gamer glove 10 comprises at least one glove attachment device 30 coupled to the palm side 12 of the glove 10. As shown in FIG. 6, a handle 102 of a controller 100 comprises at least one controller attachment device 104 coupled to the handle 102 of the controller 100. The at least one glove attachment device 30 corresponds to the at least one controller attachment device 104 coupled to the handle 102.

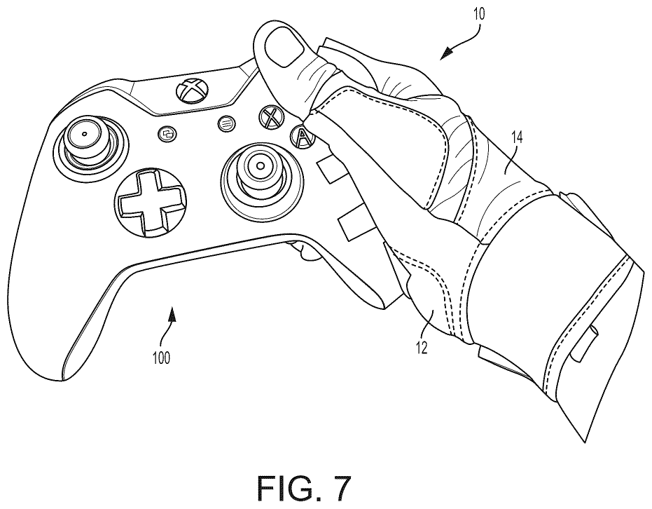

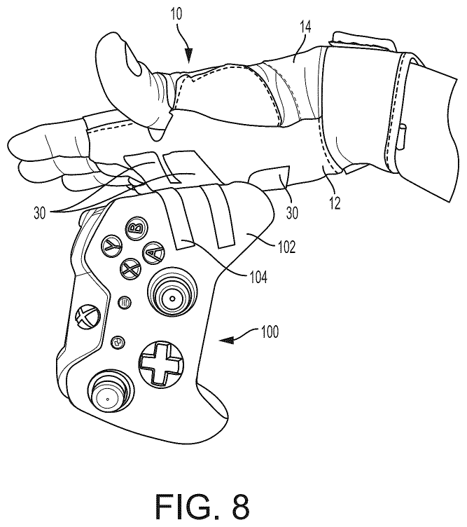

Referring to FIGS. 7 and 8, the at least one glove attachment device 30 may be releasably coupled to the at least one controller attachment device 104. This allows for the glove 10 with attachment device 30 to be coupled to the controller 100 to provide the same benefits and utilization of the glove 10 having attachment device 20 coupled to the controller 100. In embodiments, the at least one glove attachment device 30 and the at least one controller attachment device 104 may be hook-and-loop fasteners that may be releasably coupled together. In other embodiments, the at least one glove attachment device 30 and the at least one controller attachment device 104 may be magnetic fasteners that may be releasably coupled together. This allows for the glove 10 with attachment device 30 to be coupled to the controller 100 to provide the same benefits and utilization of the glove 10 having attachment device 20 coupled to the controller 100. It is understood that the at least one glove attachment device 30 and the at least one controller attachment device 104 include hook-and-loop or magnetic fasteners, they may be formed of any material that allows them to be releasably coupled together.

The location and orientation of the attachment device 20 or attachment device 30 may be adjusted to create models for various controllers and joysticks for game systems, such as, but not limited to Xbox, PlayStation, Oculus, and other PC gaming controllers and joysticks. Based on attachment device 20 or attachment device 30 positioning, embodiment may also be created for specific types of gamers such as “Standard Grip”, “Pro Claw Grip” and specific grips for disabled or injured gamers.

Embodiments includes a method of using a gamer glove. The method comprises coupling a gamer glove to the hand of a user, the gamer glove comprising an attachment device; coupling a handle of a controller to the attachment device of the gamer glove; holding the controller with the hand of the user utilizing only the attachment device; and operating the controller to play a game.

Embodiments of the glove 10 may be used for “Standard Grip” gamers as shown in FIGS. 2-3 and 6-7, the attachment device 20 or the attachment device 30 coupled to the controller 30 operate to reduce the need for gripping the controller 100 during extended play, allowing for a longer more comfortable experience.

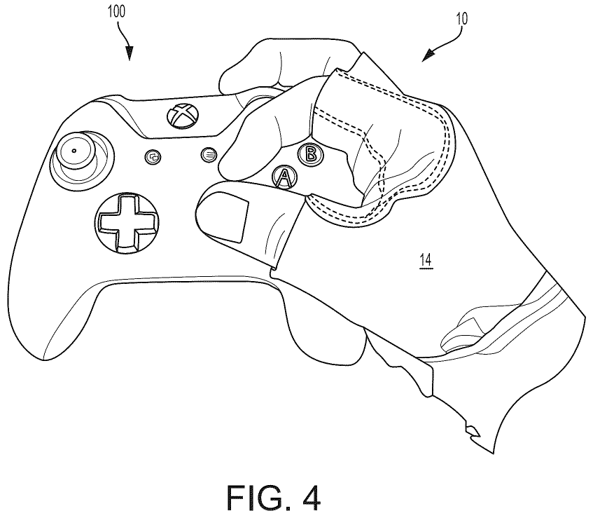

Embodiments of the glove 10 may be used for “Pro Claw Gamers” as shown in FIG. 4, the attachment device 20 or the attachment device 30 coupled to the controller 30 allows a gamer to rotate his or her right hand, allowing easy access to all buttons, toggle and bumpers. Also, the attachment device 20 or the attachment device 30 coupled to the controller 30 allows the gamer to reduce the need for gripping remote during a long session which in turn reduces hand fatigue.

Embodiments of the glove 10 may be used for injured or handicapped gamers, the attachment device 20 or the attachment device 30 operate to hold the controller 100, a gamer with a hand injury or missing certain digits can now enjoy the gaming experience with less concern for dropping the controller 100. In these embodiments, the gamer glove 10 may be, without limitation, an assistive technology.

Embodiments of the glove 10 may be utilized for VR systems, such as, but not limited to, and Oculus. In these embodiments, the attachment device 20 or the attachment device 30 operate to hold the VR remote/controller securely in hand, adding grip stability during rigorous game play. This will reduce hand fatigue and potential damage caused by flying remotes during VR motion gameplay, and serves as an assistive technology.

Referring to the embodiments depicted in FIGS. 1A-8, the gamer glove 10 may further comprise haptic devices (not shown). These haptic devices may operate to provide vibration corresponding to the game play and the haptic capability and operation of the controller 100 coupled to the gamer glove 10.

Configurations of embodiments are endless, allowing the gamer to accessorize their gloves according to their gaming system, play style and personal style. Sports teams, popular games, comic heroes/villains and current events all have the potential to influence new designs.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A gamer glove comprising:
a glove body portion having a palm side and a back side;
an attachment device coupled to the glove; and
an opening formed between the attachment device and palm side of the glove, wherein the opening receives a handle of a controller within the opening and with the attachment device and the palm side of the glove engage the handle of the controller.

2. The gamer glove of claim 1, wherein the attachment device is a strap coupled to the palm side of the glove.

3. The gamer glove of claim 2, wherein the strap is formed of an elastomeric material.

4. The gamer glove of claim 3, wherein the strap comprises at least one gripping member, wherein the at least one gripping member is coupled to an inner surface of the strap.

5. The gamer glove of claim 4, wherein the gripping members is formed of silicone.

6. The gamer glove of claim 1, wherein the attachment device is a strap coupled to the back side of the glove and wraps around to the glove to form the opening between the strap and the palm side of the glove.

7. A gamer glove comprising:
a glove body portion having a palm side and a back side;
at least one glove attachment device coupled to the palm side of the glove; and
at least one controller attachment device coupled to a handle of a controller, wherein the at least one glove attachment device is releasably coupled to the at least one controller attachment device.

8. The gamer glove of claim 7, wherein the at least one glove attachment device is a hook-and-loop fastener.

9. The gamer glove of claim 8, wherein the at least one controller attachment device is a hook-and-loop fastener to couple the at least one glove attachment device.

10. The gamer glove of claim 7, the at least one glove attachment device is a magnetic fastener.

11. The gamer glove of claim 10, wherein the at least one controller attachment device is a magnetic fastener to couple the at least one glove attachment device.

12. A method of using a gamer glove, the method comprising:
coupling a gamer glove to the hand of a user, the gamer glove comprising an attachment device;
coupling a handle of a controller to the attachment device of the gamer glove;
holding the controller with the hand of the user utilizing only the attachment device; and
operating the controller to play a game.

13. The method of claim 12, wherein the attachment device of the gamer glove comprises:
a glove body portion having a palm side and a back side;
the attachment device coupled to the palm side of the glove; and
an opening formed between the attachment device and palm side of the glove.

14. The method of claim 13, wherein coupling the handle of the controller to the attachment device of the gamer glove comprises inserting the handle of the controller within the opening and with the attachment device and the palm side of the glove engaging the handle of the controller

15. The method of claim 14, wherein the attachment device is a strap.

16. The method of claim 15, wherein the strap is formed of an elastomeric material.

17. The method of claim 16, wherein the strap comprises at least one gripping member, wherein the at least one gripping member is coupled to an inner surface of the strap.

18. The method of claim 17, wherein the gripping members is formed of silicone.

19. The method of claim 14, wherein operating the controller to play the game comprises using a standard grip.

20. The method of claim 14, wherein operating the controller to play the game comprises using a pro claw grip.
